(19) United States
(12) Patent Application Publication
(10) Pub. No.: US 2025/0386779 A1
(43) Pub. Date: Dec. 25, 2025

(54) AN IRRIGATION MAINTENANCE SYSTEM FOR DETERMINING IRRIGATION VALVE AND BOOSTER PUMP HEALTH

(71) Applicant: Heartland Ag Tech, Inc., Hancock, WI (US)

(72) Inventors: Russell Sanders, Minnetonka, MN (US); Jeremie Pavelski, Wisconsin Rapids, WI (US); Robert Buchberger, Hancock, WI (US)

(21) Appl. No.: 19/107,707

(22) PCT Filed: Sep. 1, 2023
(86) PCT No.: PCT/US2023/031822

§ 371 Date: Feb. 28, 2025

Related U.S. Application Data
(60) Provisional application No. 63/403,088, filed on Sep. 1, 2022.

(51) Int. Cl. A01G 25/16; A01G 25/09

(52) U.S. Cl. CPC A01G 25/16; A01G 25/092

(57) ABSTRACT

An irrigation maintenance system effectuates maintenance of an irrigation system that includes a nozzle for dispensing irrigation fluid, and a valve and/or booster pump for controlling pressure of the irrigation fluid dispensed from the nozzle. The irrigation maintenance system includes a fluid pressure sensor configured to generate electrical signals indicative of the pressures of the irrigation fluid at the nozzle over time, a processor, and a memory. The memory includes instructions, which, when executed by the processor, cause the irrigation maintenance system to: obtain the generated electrical signals; determine a rate of pressurization or depressurization of the irrigation fluid at the nozzle based on the generated electrical signals; and predict when the valve and/or the booster pump of the irrigation system is at or nearing end of life based on comparing the determined rate of pressurization or depressurization to a threshold value.

### CROSS-REFERENCE TO RELATED APPLICATIONS

This application is a National Phase of International Application No. PCT/US2023/031822, filed Sep. 1, 2023, which claims the benefit of U.S. Provisional Patent Application No. 63/403,088, filed on Sep. 1, 2022, the entire contents of which are hereby incorporated herein by reference.

### TECHNICAL FIELD

This disclosure relates to irrigation systems and, more particularly, to structures and methods for effectuating irrigation valve and booster pump health and control with irrigation systems.

### BACKGROUND

Irrigation systems such as pivots, lateral move systems, drip irrigation systems, etc. breakdown on average three times per year out of 40 uses. These breakdowns occur during critical growing steps and in many cases in the middle of the field.

For example, components that can suffer from a breakdown include valves and pumps in the irrigation system that control fluid pressure. End gun valves are a common cause of low pressure and/or end gun failure. The end gun valve is a mechanical component that suffers from fatigue over time which can cause low pressure and eventually results in end gun failure. Booster pumps are another common cause for failure in the end gun system. The amount of pressure the booster pumps exert when operating is critical to proper operation of the end gun systems. Excessive wear of the impeller, the motor, and/or the contactor of the booster pumps can lead to lower pressure and/or failure in the end gun system.

### SUMMARY

To limit delays, increased costs and other problems associated with irrigation system breakdown, this disclosure details a solution including digital observation of the irrigation system during normal operation and set parameters that indicate abnormal operation. To observe these operational anomalies, sensors may be added to the irrigation system to provide data for algorithms to process. These algorithms may be logic or analytics based. Existing operational data from “off the shelf” data sources may be used in some cases. In aspects, other data sources may be external to the system such as National Oceanic and Atmospheric Administration (NOAA) weather, topographical maps, soil moisture, etc., or combinations thereof.

In accordance with aspects of the disclosure, an irrigation maintenance system for effectuating maintenance of an irrigation system is presented. The irrigation system includes at least one nozzle for dispensing irrigation fluid, and a valve and/or booster pump for controlling a pressure of the irrigation fluid dispensed from the at least one nozzle. The irrigation maintenance system includes a fluid pressure sensor configured to generate electrical signals indicative of the pressures of the irrigation fluid at the at least one nozzle over time; a processor; and a memory. The memory includes instructions stored thereon, which, when executed by the processor, cause the irrigation maintenance system to: obtain the generated electrical signals; determine a rate of pressurization or depressurization of the irrigation fluid at the at least one nozzle based on the generated electrical signals; and predict when the valve and/or the booster pump of the irrigation system is at or nearing end of life based on comparing the determined rate of pressurization or depressurization of the irrigation fluid at the at least one nozzle to a threshold value.

In an aspect of the present disclosure, the instructions, when executed, may further cause the irrigation maintenance system to: provide an indication to a user when the valve and/or the booster pump is at or nearing end of life based on the determination.

In another aspect of the present disclosure, the fluid pressure sensor may be disposed adjacent to the at least one nozzle.

In yet another aspect of the present disclosure, the fluid pressure sensor may be coupled to an end portion of a span of a pivot of the irrigation system.

In a further aspect of the present disclosure, the at least one nozzle may be supported on a movable end gun of the irrigation system.

In an aspect of the present disclosure, the nozzle may be movably mounted on a pivot of the irrigation system.

In another aspect of the present disclosure, the irrigation maintenance system may further include an analytics engine configured to perform the determinations, wherein the analytics engine includes a machine learning model, and wherein the machine learning model is based on a deep learning network, a classical machine learning model, or combinations thereof.

In yet another aspect of the present disclosure, the instructions, when executed, may further cause the irrigation maintenance system to: input the determined rate of pressurization or depressurization of the irrigation fluid at the at least one nozzle into the analytics engine; and predict by the analytics engine when the valve and/or the booster pump is at or nearing end of life

In a further aspect of the present disclosure, the instructions, when executed, may further cause the irrigation maintenance system to: remediate the valve and/or the booster pump by energizing and/or de-energizing the valve and/or the booster pump in a predetermined pattern in response to the determination that the valve and/or the booster pump is nearing end of life.

In an aspect of the present disclosure, a computer-implemented method for irrigation system maintenance is presented. The irrigation system includes at least one nozzle for dispensing irrigation fluid, and a valve and/or booster pump for controlling a pressure of the irrigation fluid dispensed from the at least one nozzle. The method includes: obtaining from a fluid pressure sensor, electrical signals indicative of a pressure of an irrigation fluid at a valve operatively coupled to the at least one nozzle, the valve configured to control pressurization and/or depressurization of the irrigation system; determining a rate of pressurization or depressurization of the irrigation fluid at the at least one nozzle based on the generated electrical signals; and determining when the valve and/or the booster pump is at or nearing end of life based on comparing the determined rate of pressurization or depressurization of the irrigation fluid at the at least one nozzle to a threshold value.

In another aspect of the present disclosure, the method may further include providing an indication to a user when the valve and/or the booster pump is at or nearing end of life based on the determination.

In a further aspect of the present disclosure, the method may further include performing edge detection to the determined rate of pressurization or depressurization of the irrigation fluid at the at least one nozzle based on the generated electrical signals.

In a further aspect of the present disclosure, the method may further include predicting when the valve and/or the booster pump is at or nearing end of life based on the edge detection.

In a further aspect of the present disclosure, the determinations may be performed by an analytics engine, wherein the analytics engine includes a machine learning model, and wherein the machine learning model is based on a deep learning network, a classical machine learning model, or combinations thereof.

In yet another aspect of the present disclosure, the method may further include inputting the determined rate of pressurization and/or depressurization of the irrigation fluid at the at least one nozzle into the analytics engine; and predicting by the analytics engine when the valve and/or the booster pump is at or nearing end of life.

In a further aspect of the present disclosure, the method may further include remediating the valve and/or the booster pump by energizing and/or de-energizing the valve and/or the booster pump in a predetermined pattern in response to the determination that the valve and/or the booster pump is nearing end of life.

In a further aspect of the present disclosure, the method may further include controlling the energizing and/or de-energizing of the valve and/or the booster pump using a pulse waveform.

In a further aspect of the present disclosure, the method may further include controlling the frequency of a pulse and/or a pulse width of the pulse waveform.

In an aspect of the present disclosure, a non-transitory computer-readable medium storing instructions which, when executed by a processor, cause the processor to perform a method is presented. The method includes obtaining from a fluid pressure sensor, electrical signals indicative of a pressure of an irrigation fluid at a valve operatively coupled to the at least one nozzle, the valve configured to control pressurization and/or depressurization of the irrigation system; determining a rate of pressurization or depressurization of the irrigation fluid at the at least one nozzle based on the generated electrical signals; determining when the valve and/or the booster pump is at or nearing end of life based on comparing the determined rate of pressurization or depressurization of the irrigation fluid at the at least one nozzle to a threshold value; and remediating the valve and/or booster pump by energizing and/or de-energizing the valve in a predetermined pattern in response to the determination that the valve is nearing end of life.

Other aspects, features, and advantages will be apparent from the description, the drawings, and the claims that follow.

### BRIEF DESCRIPTION OF DRAWINGS

The accompanying drawings, which are incorporated in and constitute a part of this specification, illustrate aspects of the disclosure and, together with a general description of the disclosure given above and the detailed description given below, serve to explain the principles of this disclosure, wherein:

FIG. 1 is a diagram illustrating an irrigation maintenance system in the form of a monitoring or predictive maintenance system in accordance with the principles of this disclosure;

FIG. 2 is a block diagram of a controller configured for use with the predictive maintenance system of FIG. 1;

FIG. 3 is a diagram illustrating a machine learning model configured for use with the predictive maintenance system of FIG. 1;

FIG. 4A illustrates an exemplary flow chart of a typical farm operation;

FIG. 4B illustrates an exemplary flow chart of a farm operation, including a predictive maintenance system in accordance with the principles of this disclosure;

FIG. 5 illustrates a data science workflow with various models of the predictive maintenance system illustrated in FIG. 1;

FIGS. 6-8 are diagrams of example hardware interface and instrumentation of the predictive maintenance system of FIG. 1;

FIG. 9 is a perspective view of a portion of an exemplary pivot of the predictive maintenance system of FIG. 1;

FIG. 10 is a perspective view of a portion of air compressor instrumentation of another exemplary pivot of the predictive maintenance system of FIG. 1;

FIG. 11A is a perspective view of an end gun assembly of the predictive maintenance system;

FIG. 11B is a cross-sectional view of the end gun assembly of FIG. 11A;

FIG. 12 is a flow diagram of a method for monitoring fluid pressure in an irrigation system, with the predictive maintenance system of FIG. 1 in accordance with the principles of this disclosure;

FIG. 13 is a graph illustrating end gun pressure vs. time, in accordance with the principles of this disclosure;

FIG. 14 is a graph illustrating end gun pressure vs. time for a healthy valve in accordance with the principles of this disclosure;

FIG. 15 is a rear perspective view of an example end gun and pressure sensor in accordance with the principles of this disclosure;

FIG. 16 is a bottom perspective view of an example end gun with a remote-mounted booster and pressure sensor in accordance with the principles of this disclosure; and

FIG. 17 is a side perspective view illustrating an example booster and pressure sensor mounted adjacent to the end gun of FIG. 15 in accordance with the principles of this disclosure.

### DETAILED DESCRIPTION

Aspects of the disclosed predictive maintenance systems are described in detail with reference to the drawings, in which like reference numerals designate identical or corresponding elements in each of the several views. Directional terms such as top, bottom, and the like are used simply for convenience of description and are not intended to limit the disclosure attached hereto. Also, as used herein, the term “on” includes being in an open or activated position, whereas the term “off” includes being in a closed or inactivated position.

In the following description, well-known functions or constructions are not described in detail to avoid obscuring the present disclosure in unnecessary detail.

Advantageously, the disclosed system monitors aspects of an irrigation system (e.g., transient pressure as the end gun is turned on and off), to determine whether a valve or other component is near “end of life” (i.e., about to fail).

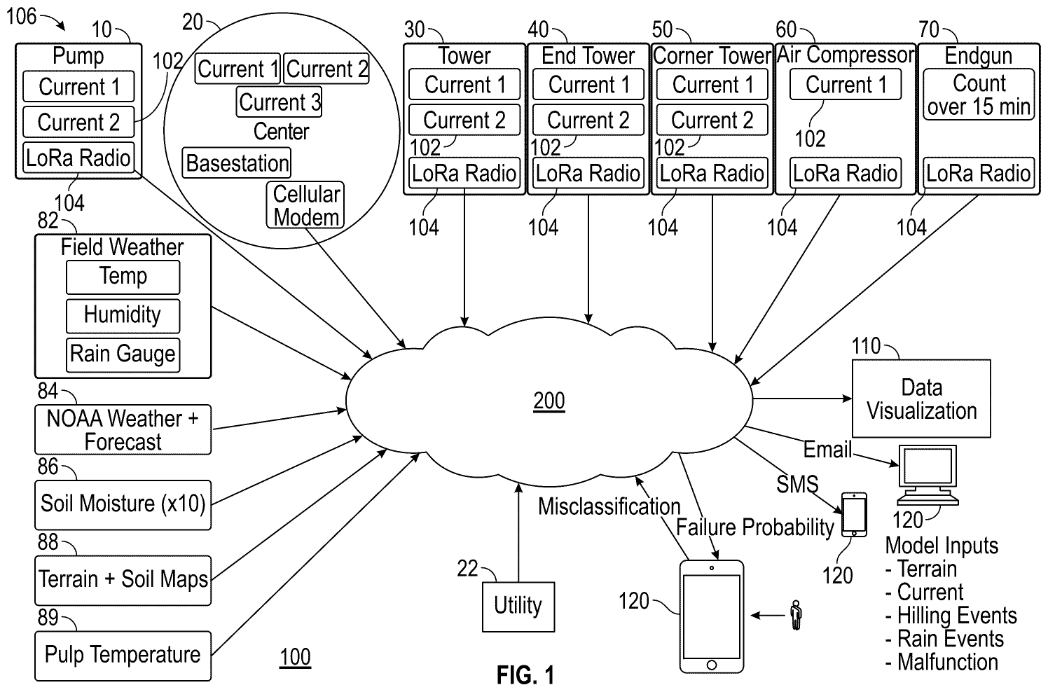

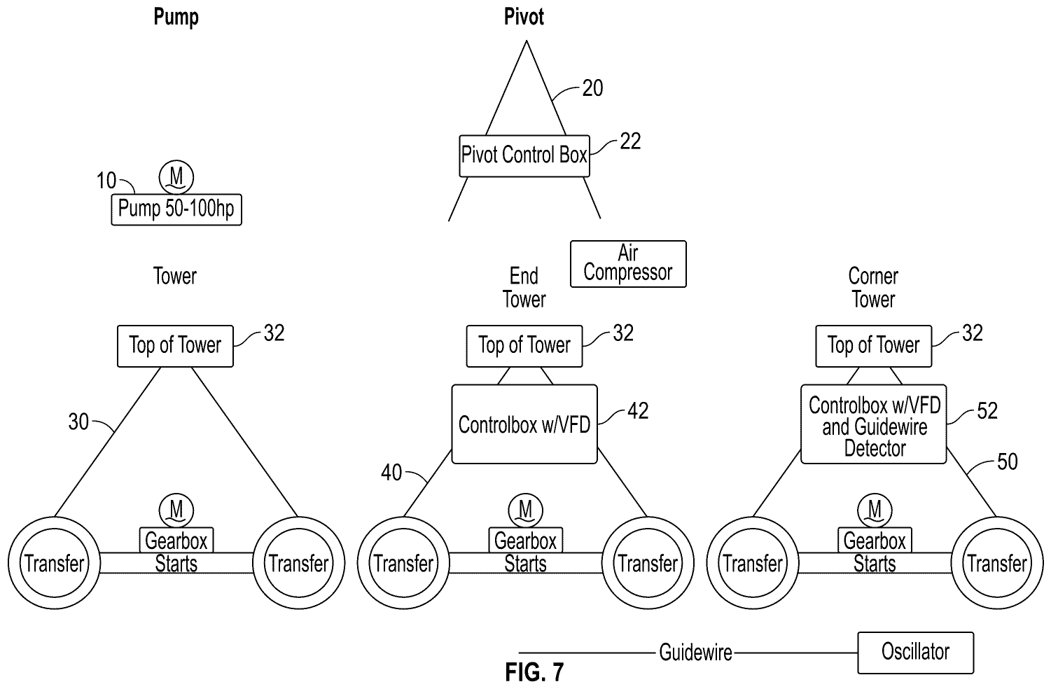

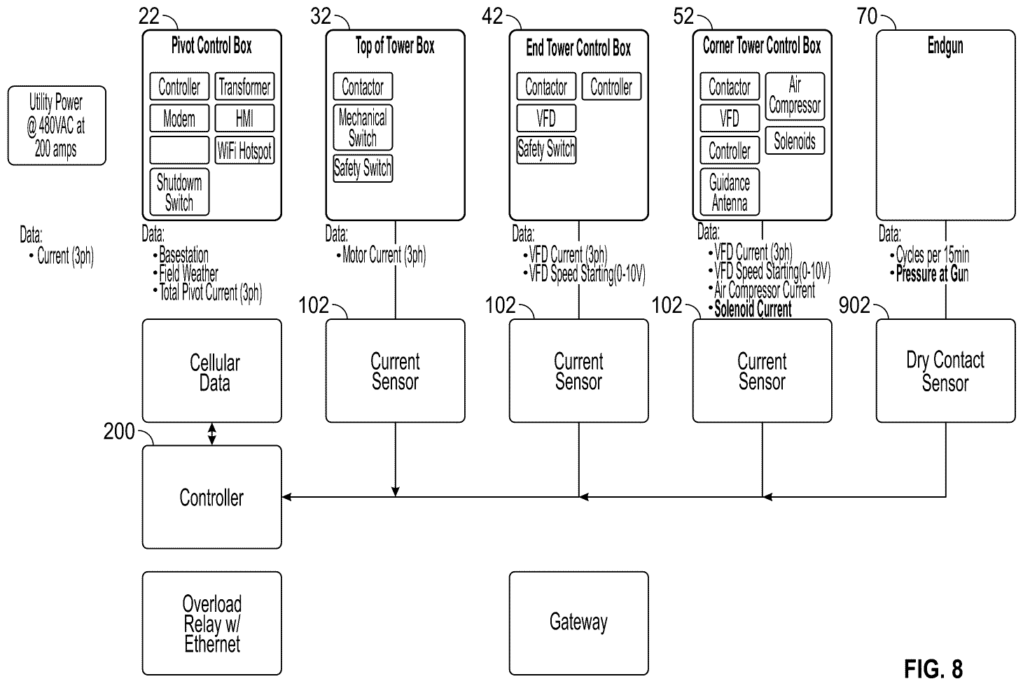

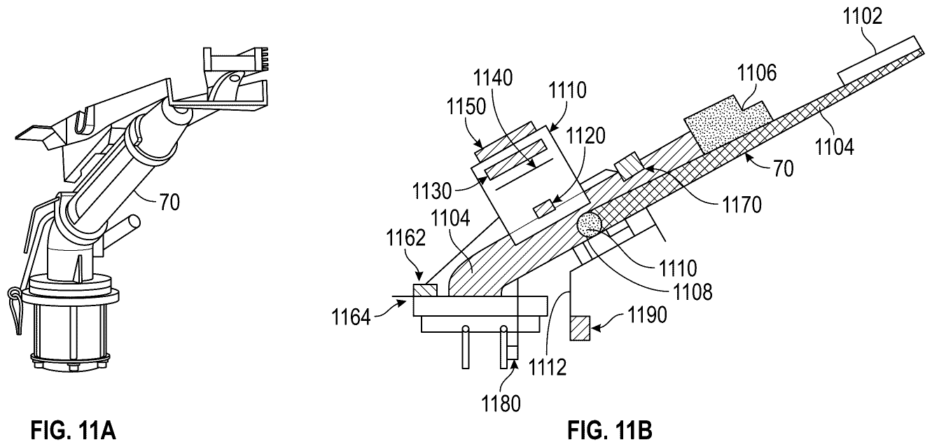

With reference to FIGS. 1 and 7-9, a monitoring system 100 for an irrigation system (for farming, mining, etc.) is provided. Generally, the monitoring system 100 includes an irrigation system 106 and a controller 200 configured to execute instructions controlling the operation of the monitoring system 100. The irrigation system 106 may include a pump 10 (e.g., a compressor or booster pump, see FIG. 11), a pivot 20, one or more towers 30, an end tower 40, a corner tower 50, an air compressor 60, and an end gun 70 (also known as a big gun, big volume gun, and/or moveable nozzle). The pump 10 may include one or more current sensors and a wireless communication device 104 configured to transmit data wirelessly to the controller 200 (e.g., sensed current data). The pivot 20 may include one or more sensors 102 and a wireless communication device 104 configured to transmit data wirelessly to the controller 200. Each tower 30, corner tower 50, and end tower 40 may include one or more sensors 102 and a wireless communication device 104 configured to transmit data wirelessly to the controller 200. The wireless communication device may include, for example, 3G, LTE, 4G, 5G, Bluetooth, and/or Wi-Fi, etc. The sensors 102 may include at least one of a current sensor, a voltage sensor, and/or a power sensor configured to sense, for example, current, voltage, and/or power, respectively. In aspects, these sensors 102 may measure the transmission of electricity into a motor of the booster pump 10 motor when part of the system. The pump 10 may include the transmission lines on the span; a contactor; and components used to actuate the contactor, the motor components, including the electrical components, mechanical components, and the pump components including the impeller, inlet, outlet, and/or tubing. In aspects, the pump 10 may include a flow sensor (not shown) on the booster pump outlet.

In aspects, the one or more sensors 102 can include any suitable sensors such as, for example, an encoder (e.g., an angular encoder), pressure sensor, flow meter, etc., or combinations thereof. An angular encoder may be in a form of a position sensor that measures the angular position of a rotating shaft.

In aspects, the one or more sensors may be connected (e.g., directly) and/or may be standalone components that may be connected via wide area network (WAN). In aspects, the one or more sensors may be aggregated in the cloud based on provisioning settings. In aspects, the one or more sensors may include, for example, low-power wide area network technology (LPWAN) which may be long-range (LoRa).

In aspects, the controller 200 may determine changes in the condition of the at least one component based on comparing the generated signal to predetermined data.

The controller 200 is configured to receive data from the sensors 102 as well as from external data sources such as weather stations 82, field soil moisture sensors 86, terrain and soil maps 88, temperature sensors 89, and/or National Oceanic and Atmospheric Administration (NOAA) weather 84 to make and/or refine predictions indicative of a condition of at least one component (e.g., a pivot 20, an end gun 70, a tower 30, etc.) of the plurality of components of the irrigation system 106. This prediction enables the controller 200 to determine changes in the condition of the at least one component and predict fertilization requirements (e.g., volume/time) of a predetermined area (e.g., a farming area or field requiring irrigation and/or fertilization) based on predetermined data (e.g., historical data). For example, the prediction may be based on comparing the determined changes in the condition of at least one component of the irrigation system 106 to predetermined data. For example, the sensor 102 of a tower 30 (or pivot 20, or end gun 70, etc.) may sense the current draw of that tower 30 (or pivot 20, or end gun 70, etc.). The sensed current draw may then be compared by the controller 200 to a predetermined current draw for that tower 30 which may be a baseline current draw, an historical current draw, and/or a typical current draw for that tower 30 or other towers. The controller may determine that the sensed current draw of this tower 30 is considerably higher than the predetermined current draw by a predetermined number (e.g., about 30%) for a particular set of conditions (sunny day, dry soil, etc.). Based on this determination, the controller 200 may predict that this tower 30 is irrigating at a slower rate than normal. In another example, the system may sense, by the sensor 102, that the current on a pump 10 is low, and, accordingly, predict that the pump 10 is not pumping enough water. In an example, a terrain map identifies when the pivot 20 is sloped down-hill, thus increasing the pressure at the end gun 70, which facilitates a determination of why pressure is higher for that particular area and that the rate of fertilization may need to be changed. In aspects, the system may use the maintenance requirements of the irrigation system to determine the amount of fertilization required for an area (e.g., a field, zone, quadrant, etc.).

Data from external data sources may be used to improve model predictions. For example, by processing data such as higher power use by motors of the towers 30 because the field is muddy due to recent rain, such processed data can be used to improve model predictions. The monitoring system 100 may display field maps for terrain, soil types, etc., that help the model explain variations in power use. The predictions may be transmitted to a user device 120, by the controller 200, for display and/or further analysis.

In aspects, the data and/or predictions may be processed by a data visualization system 110. Data visualization is the graphical representation of information and data. By using visual elements like charts, graphs, and maps, data visualization tools provide an accessible way to see and understand trends, outliers, and patterns in data.

In aspects, the monitoring system 100 may be implemented in the cloud. For instance, Linux, which may run a Python script, for example, can be utilized to effectuate prediction.

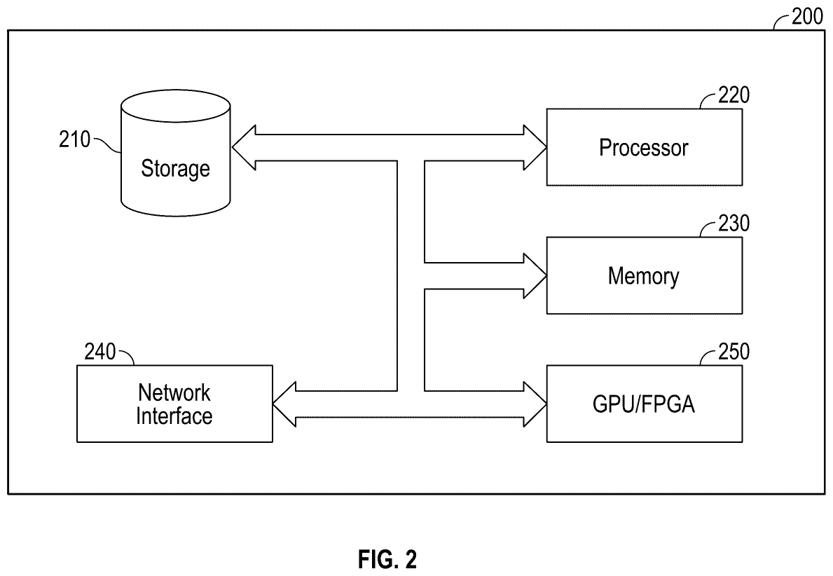

FIG. 2 illustrates that controller 200 includes a processor 220 connected to a computer-readable storage medium or a memory 230. The computer-readable storage medium or memory 230 may be a volatile type of memory, e.g., RAM, or a non-volatile type of memory, e.g., flash media, disk media, etc. In various aspects of the disclosure, the processor 220 may be another type of processor, such as a digital signal processor, a microprocessor, an ASIC, a graphics processing unit (GPU), a field-programmable gate array (FPGA), or a central processing unit (CPU). In certain aspects of the disclosure, network inference may also be accomplished in systems that have weights implemented as memristors, chemically, or other inference calculations, as opposed to processors.

In aspects of the disclosure, the memory 230 can be random access memory, read-only memory, magnetic disk memory, solid-state memory, optical disc memory, and/or another type of memory. In some aspects of the disclosure, the memory 230 can be separate from the controller 200 and can communicate with the processor 220 through communication buses of a circuit board and/or through communication cables such as serial ATA cables or other types of cables. The memory 230 includes computer-readable instructions that are executable by the processor 220 to operate the controller 200. In other aspects of the disclosure, the controller 200 may include a network interface 240 to communicate with other computers or to a server. A storage device 210 may be used for storing data.

The disclosed method may run on the controller 200 or on a user device, including, for example, on a mobile device, an IoT device, or a server system.

In aspects, an analytics engine (e.g., a machine learning model and/or classical analytics) may be configured to perform the determinations.

Moreover, the disclosed structure can include any suitable mechanical, electrical, and/or chemical components for operating the disclosed pivot predictive maintenance system or components thereof. For instance, such electrical components can include, for example, any suitable electrical and/or electromechanical, and/or electrochemical circuitry, which may include or be coupled to one or more printed circuit boards. As used herein, the term “controller” includes “processor,” “digital processing device” and like terms, and are used to indicate a microprocessor or central processing unit (CPU). The CPU is the electronic circuitry within a computer that carries out the instructions of a computer program by performing the basic arithmetic, logical, control and input/output (I/O) operations specified by the instructions, and by way of non-limiting examples, include server computers. In some aspects, the controller includes an operating system configured to perform executable instructions. Those of skill in the art will recognize that suitable server operating systems include, by way of non-limiting examples, FreeBSD, OpenBSD, NetBSD®, Linux, Apple® Mac OS X Server®, Oracle® Solaris®, Windows Server®, and Novell® NetWare®. In some aspects, the operating system is provided by cloud computing.

In some aspects, the term “controller” may be used to indicate a device that controls the transfer of data from a computer or computing device to a peripheral or separate device and vice versa, and/or a mechanical and/or electromechanical device (e.g., a lever, knob, etc.) that mechanically operates and/or actuates a peripheral or separate device.

In aspects, the controller includes a storage and/or memory device. The storage and/or memory device is one or more physical apparatus used to store data or programs on a temporary or permanent basis. In some aspects, the controller includes volatile memory and requires power to maintain stored information. In various aspects, the controller includes non-volatile memory and retains stored information when it is not powered. In some aspects, the non-volatile memory includes flash memory. In certain aspects, the non-volatile memory includes dynamic random-access memory (DRAM). In some aspects, the non-volatile memory includes ferroelectric random-access memory (FRAM). In various aspects, the non-volatile memory includes phase-change random access memory (PRAM). In certain aspects, the controller is a storage device including, by way of non-limiting examples, CD-ROMs, DVDs, flash memory devices, magnetic disk drives, magnetic tapes drives, optical disk drives, and cloud computing-based storage. In various aspects, the storage and/or memory device is a combination of devices such as those disclosed herein.

In some aspects, the controller includes a display to send visual information to a user. In various aspects, the display is a cathode ray tube (CRT). In various aspects, the display is a liquid crystal display (LCD). In certain aspects, the display is a thin film transistor liquid crystal display (TFT-LCD). In aspects, the display is an organic light emitting diode (OLED) display. In certain aspects, on OLED display is a passive-matrix OLED (PMOLED) or active-matrix OLED (AMOLED) display. In aspects, the display is a plasma display. In certain aspects, the display is a video projector. In various aspects, the display is interactive (e.g., having a touch screen or a sensor such as a camera, a 3D sensor, a LiDAR, a radar, etc.) that can detect user interactions/gestures/responses and the like. In some aspects, the display is a combination of devices such as those disclosed herein.

The controller may include or be coupled to a server and/or a network. As used herein, the term “server” includes “computer server,” “central server,” “main server,” and like terms to indicate a computer or device on a network that manages the system, components thereof, and/or resources thereof. As used herein, the term “network” can include any network technology including, for instance, a cellular data network, a wired network, a fiber optic network, a satellite network, and/or an IEEE 802.11a/b/g/n/ac wireless network, among others.

In various aspects, the controller can be coupled to a mesh network. As used herein, a “mesh network” is a network topology in which each node relays data for the network. All mesh nodes cooperate in the distribution of data in the network. It can be applied to both wired and wireless networks. Wireless mesh networks can be considered a type of “Wireless ad hoc” network. Thus, wireless mesh networks are closely related to Mobile ad hoc networks (MANETs). Although MANETs are not restricted to a specific mesh network topology, Wireless ad hoc networks or MANETs can take any form of network topology. Mesh networks can relay messages using either a flooding technique or a routing technique. With routing, the message is propagated along a path by hopping from node to node until it reaches its destination. To ensure that all its paths are available, the network must allow for continuous connections and must reconfigure itself around broken paths, using self-healing algorithms such as Shortest Path Bridging. Self-healing allows a routing-based network to operate when a node breaks down or when a connection becomes unreliable. As a result, the network is typically quite reliable, as there is often more than one path between a source and a destination in the network. This concept can also apply to wired networks and to software interaction. A mesh network whose nodes are all connected to each other is a fully connected network.

In some aspects, the controller may include one or more modules. As used herein, the term “module” and like terms are used to indicate a self-contained hardware component of the central server, which in turn includes software modules. In software, a module is a part of a program. Programs are composed of one or more independently developed modules that are not combined until the program is linked. A single module can contain one or several routines, or sections of programs that perform a particular task.

As used herein, the controller includes software modules for managing various aspects and functions of the disclosed system or components thereof.

The disclosed structure may also utilize one or more controllers to receive various information and transform the received information to generate an output. The controller may include any type of computing device, computational circuit, or any type of processor or processing circuit capable of executing a series of instructions that are stored in memory. The controller may include multiple processors and/or multicore central processing units (CPUs) and may include any type of processor, such as a microprocessor, digital signal processor, microcontroller, programmable logic device (PLD), field programmable gate array (FPGA), or the like. The controller may also include a memory to store data and/or instructions that, when executed by the one or more processors, cause the one or more processors to perform one or more methods and/or algorithms.

Any of the herein described methods, programs, algorithms or codes may be converted to, or expressed in, a programming language or computer program. The terms “programming language” and “computer program,” as used herein, each include any language used to specify instructions to a computer, and include (but is not limited to) the following languages and their derivatives: Assembler, Basic, Batch files, BCPL, C, C+, C++, Delphi, Fortran, Java, JavaScript, machine code, operating system command languages, Pascal, Perl, PL1, scripting languages, Visual Basic, metalanguages which themselves specify programs, and all first, second, third, fourth, fifth, or further generation computer languages. Also included are database and other data schemas, and any other meta-languages. No distinction is made between languages which are interpreted, compiled, or use both compiled and interpreted approaches. No distinction is made between compiled and source versions of a program. Thus, reference to a program, where the programming language could exist in more than one state (such as source, compiled, object, or linked) is a reference to any and all such states. Reference to a program may encompass the actual instructions and/or the intent of those instructions.

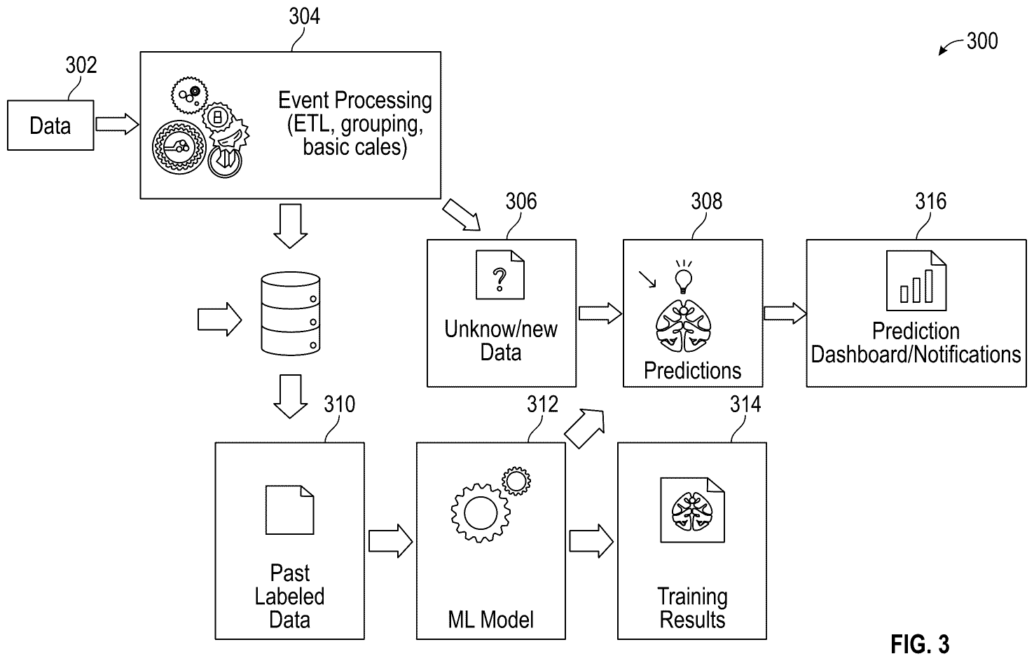

FIG. 3 illustrates a machine learning model 300 and dataflow\storage\feedback of the pivot predictive maintenance system. The machine learning model 300 can be hosted at the pivot 20 or in the cloud (e.g., a remote server). The machine learning model 300 may include one or more convolutional neural networks (CNN).

In machine learning, a convolutional neural network (CNN) is a class of artificial neural network (ANN), most commonly applied to analyzing visual imagery. The convolutional aspect of a CNN relates to applying matrix processing operations to localized portions of an image, and the results of those operations (which can involve dozens of different parallel and serial calculations) are sets of many features that are used to train neural networks. A CNN typically includes convolution layers, activation function layers, and pooling (typically max pooling) layers to reduce dimensionality without losing too many features. Additional information may be included in the operations that generate these features. Providing unique information that yields features that give the neural networks information can be used to ultimately provide an aggregate way to differentiate between different data input to the neural networks. In aspects, the machine learning model 300 may include a combination of one or more deep learning networks (e.g., a CNN), and classical machine learning models (e.g., an SVM, a decision tree, etc.). For example, the machine learning model 300 may include two deep learning networks.

In aspects, two labeling methods for the training data may be used, one based on a connection with a computer maintenance system (CMMS) and one based on user input. In aspects, the user can be prompted to label data, or can provide the data manually (e.g., at time of service events).

The machine learning (“ML”) model may be the most efficient for complex failures. However, basic logic can be used for simpler failure modes. Likely signals of abnormal operation may come from changes in transient mainline pressure and/or endgun pressure. Since these vary with a complex inference space, ML can assist in predicting abnormal operation and simplify user and subject matter expert input by giving a simple labeling method.

In aspects, the abnormal operation may be predicted by generating, based on the received first set of sensor signals, a data structure that is formatted to be processed through one or more layers of a machine learning model. The data structure may have one or more fields structuring data. The abnormal operation may further be predicted by processing data that includes the data structure, through each of the one or more layers of the machine learning model that has been trained to predict a likelihood that a particular piece of equipment may require maintenance; and generating, by an output layer of the machine learning model, an output data structure. The output data structure may include one or more fields structuring data indicating a likelihood that a particular piece of equipment may require maintenance. The abnormal operation requirement may further be predicted by processing the output data structure to determine whether data organized by the one or more fields of the output data structure satisfies a predetermined threshold, wherein the output data structure includes one or more fields structuring data indicating a likelihood that a particular piece of equipment may require maintenance; and generating the prediction based on the output data of the machine learning model. The prediction includes the abnormal operation. The training may include supervised learning.

The machine learning model may be trained based on observing the transient time the valve 902 feeding the end gun 70 takes to turn on and off, and use that as a “digital twin” to set a baseline operation to compare to when in service. In aspects, pressure transient data when the end gun 70 turns on and off may be used as an input to the machine learning model for training. The pressure transient data may be used to identify valve operation issues that can lead to the valve sticking open or closed. In aspects, irrigated acres of a field may be automatically mapped to replace or supplement the current practice of “flagging,” by which an irrigation team member drives around the field with a laser range finder and places flags to create a field map that may be used to plant and manage the field. Looking at the pressure at the end of the pivot 20 and on the end gun 70, the machine learning model may be able to identify/predict potential issues in water supplied, well, well motors, spans, VFDs, filters, booster pumps, and/or other components of the pivot. The pressure transient measurements may be sensed using a relatively high time resolution (<100 msec). In aspects, a user may configure the on and/or off zones of the end gun 70. In aspects, end gun kinematic parameters, as well as pressure transients for end gun valve pressure and/or corner arm sequencing pressure may be used as an input to the machine learning model. This reference observation may be used to enable location and/or well pressure based analytics to improve the sensitivity and accuracy of the system.

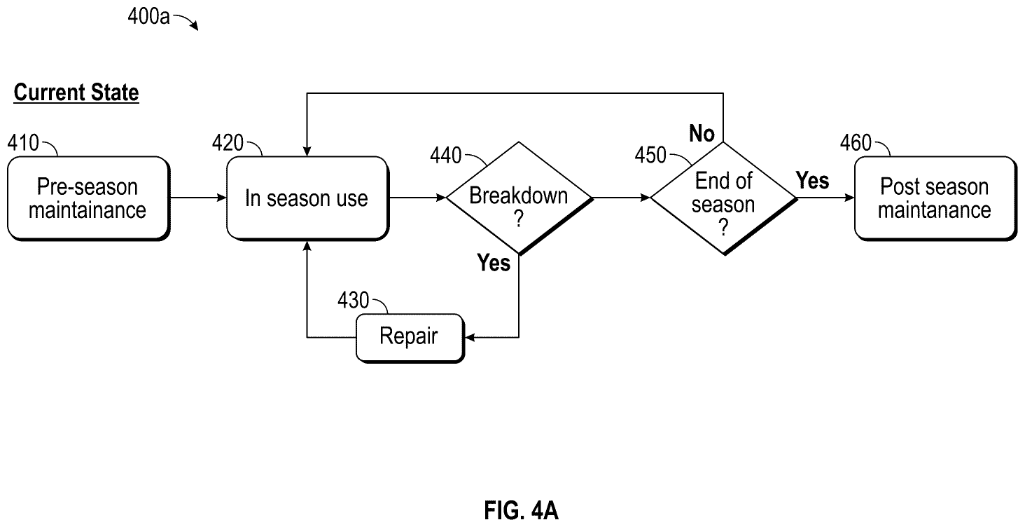

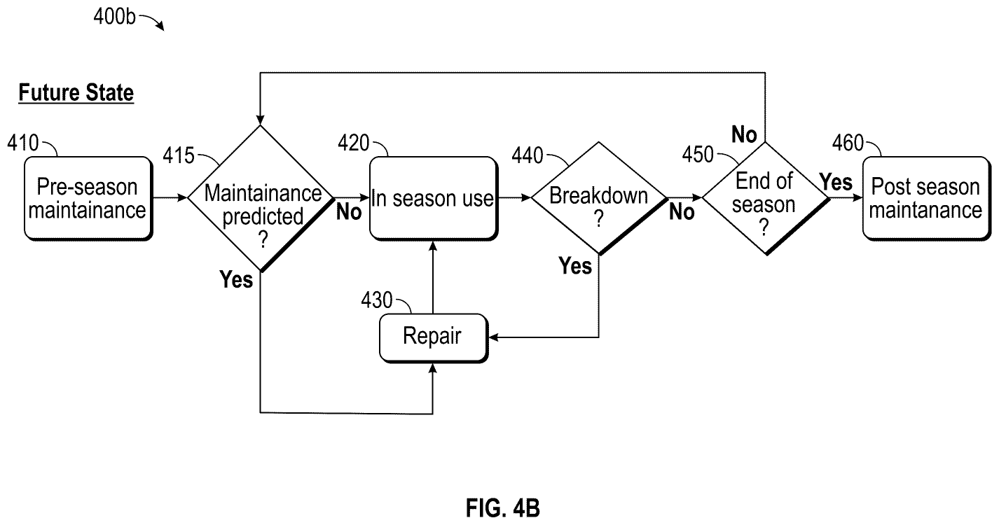

As noted above, FIG. 4A illustrates an exemplary flow chart of a typical farm operation 400a. Generally, at step 410, pre-season maintenance is performed on the irrigation equipment. Next, at step 420, the irrigation equipment is used in season. At step 440, if the equipment is determined to have broken down, it is sent in for repair at step 430. At the end of the season (step 450), post-season maintenance is performed (step 460).

FIG. 4B illustrates an exemplary flow chart 400b of a farm operation including a monitoring system 100 in accordance with the principles of this disclosure. Generally, at step 410, pre-season maintenance is performed on the irrigation equipment. Next, the monitoring system 100 predicts whether maintenance is needed for a particular piece of irrigation equipment. If maintenance is predicted at step 415, then at step 430, the equipment is examined and repaired. Next, at step 420, the irrigation equipment is used in season. At step 440, if the equipment is determined to have broken down, the equipment is sent in for repair at step 430. At the end of the season (step 450), post-season maintenance is performed (step 460).

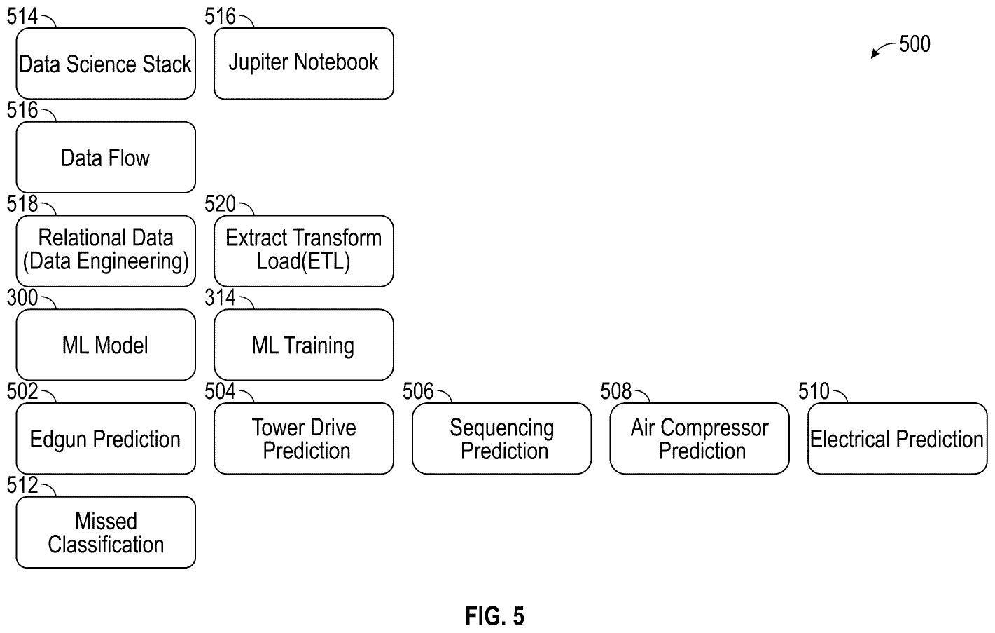

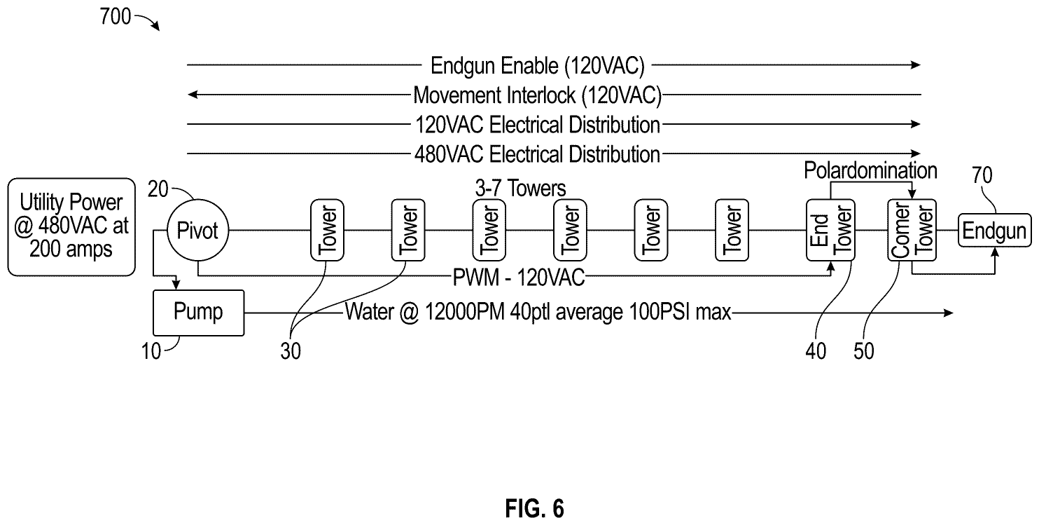

FIG. 5 illustrates a data science work-flow with various models of the predictive maintenance system illustrated in FIG. 4B.

The five models include an end gun prediction model 502, a tower drive prediction model 504, a sequencing prediction model 506, an air compression prediction model 508, and an electrical prediction model 510. The models may be implemented via logic and/or machine learning.

With reference to FIGS. 5 and 18, an end gun prediction model 502 is shown. The end gun prediction model may count the number of times the end gun 70 (FIG. 1) takes to pass from left to right and back. Expected time to pass left and right may be based on pressure, bearing condition, tension, etc., or combinations thereof.

The end gun prediction model 502 can consider expected power based on soil moisture directly measured or inferred from weather data from the field or regional weather stations, topographical maps, soil maps, motor RPM, gearbox ratio, tower weight, span weight, operating condition, etc., or combinations thereof. The end gun 70 includes instrumentation that can measure each cycle using a proximity switch, encoder, capacitance, and/or image system. Aspects of the monitoring system 100 can be mounted on or off the irrigation system 106, for example, a moisture sensor that logs when the moisture sensor is splashed remotely by the water being distributed to the field. If an electronic gun is used, energy use and duty cycle can be used. In aspects, the one or more sensors can include any suitable sensors such as, for example, an encoder (e.g., angular), pressure sensor, flow meter, magnetometer, gyroscope, accelerometer, camera, gesture sensor, microphone, laser range finder, reed/magnetic/optical switch, etc., or combinations thereof. The end gun prediction model 502 may also include as inputs the pump pressure, the model number of the end gun, the end gun nozzle diameter, the drive arm spring setting, the diffuser type, a flow measurement, a drive arm spring K-factor, a drive arm balance, a drive arm bearing condition, a base bearing condition, a base seal condition, a drive arm alignment, and/or a mounting base rigidity. The nozzle type can be inferred from a measured flow and measured pressure. In aspects, the end gun prediction model 502 may predict a drive arm impact frequency, an acceleration magnitude per drive arm impact, an angular rate forward, an angular rate reverse, a heading change rate forward or reverse, a time per pass, and/or a time to flip a reversing lever. The model outputs can be used to further predict abnormal operation.

Abnormal operation of the end gun may be further based on movement and/or positioning of the moveable end gun 70 relative to the pivot 20 (and/or other portions of the irrigation system, such as a lateral drive, a water winch, etc.) over time. For example, the monitoring system 100 may monitor the drive arm frequency using an accelerometer and/or gyroscope, and/or the heading change of the end gun 70 may be determined by a magnetometer. The end gun 70 may typically be “on” for about fifteen degrees of rotation from the time it is started to the time it is stopped. The sensor 102 may sense that the end gun 70 was on for about three degrees of rotation and the controller may determine that this was abnormal operation and that the end gun 70 may need maintenance. In aspects, the logic for determining abnormal operation may be based on a sliding window over seconds, minutes, hours, days, and/or years. In aspects, there is a traveling end gun 70 without spans known as water winches. The disclosed technology also applies to water winches and lateral move irrigation systems. In aspects, a moveable end gun 70 may be disposed on the water winch. In some examples, a water winch moves on tires, in other examples, the end gun 70 moves rotationally by the drive arm, or a gear energized by water flow. In an example, a water winch may be moved by another vehicle such as a tractor or a truck. In another example, the water winch may be pulled by a flexible water pipe pulls it along a path via a reel. In yet another example, the end gun 70 may be directly mounted on a truck to keep dust down in a mine, and/or to apply wastewater to a field. In another example, the end gun 70 may not be mounted on the pivot, but rather mounted on a boom, and/or a last regular drive unit in the pivot style irrigation system.

Monitoring output parameters such as end gun 70 timing, flow, an/or pressure can also help infer air compressor health. In aspects, abnormal operation may further be determined by the water pressure and/or volume from the end gun 70.

For example, if a user (e.g., a farmer) was applying too much pressure to the end gun 70, and the water and fertilizer may get thrown over the crop, leading to dry rings. The pressure sensor may sense that the end gun pressure was dropping to about 40 psi from a normal 71 psi. The end gun prediction model 502 may predict that the system is operating abnormally based on the pressure measurement over time. The pressure may have been initially high, and then drop about 10 psi over the next hour. The farmer may have been operating at too high of a pressure because the booster pump was dropping out and restarting frequently. The pump restarting is very detrimental to the health of the irrigation system 106, as the pump may wear out the electrical components well ahead of their rated life.

### Electrical Instrumentation

The system may also monitor contactors, commutator rings, motor windings, electrical connections, and/or wiring failures. Monitoring electrical transients or power metrics such as THD, Power Factor, current balance can help infer electrical system health.

Monitoring the temperatures of the components listed above can also help infer electrical system health.

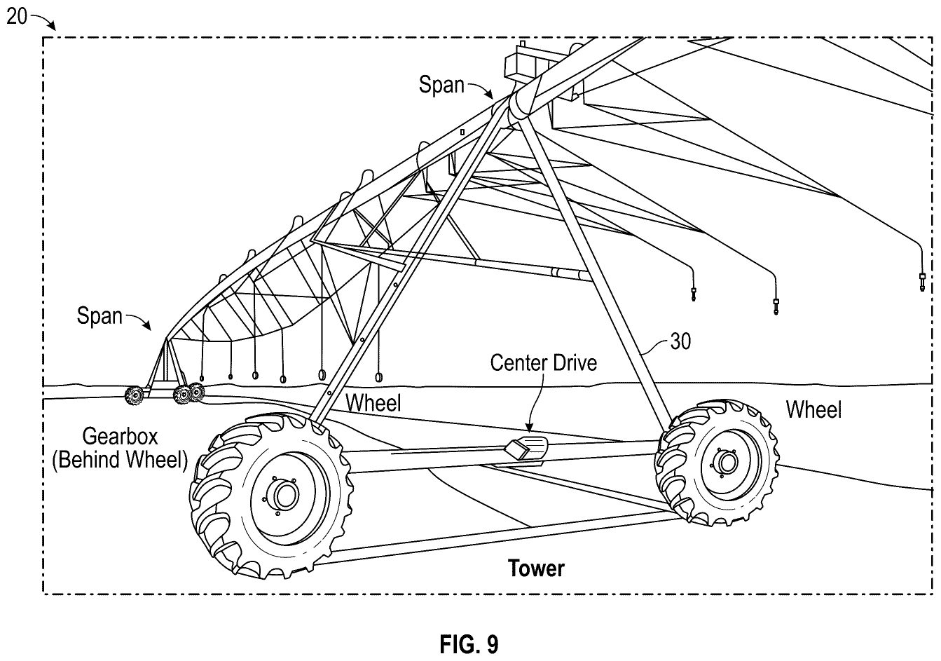

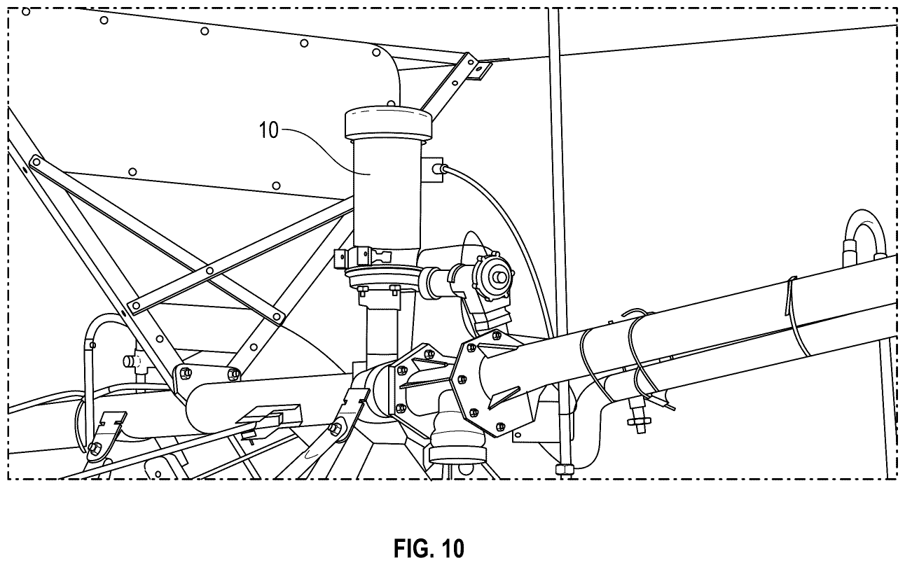

With reference to FIGS. 11A and 11B, the movable end gun 70 supports an electronics enclosure 1110 that supports at least one sensor 1120 including an accelerometer, gyroscope, a microphone, a pressure sensor, flow sensor, and/or magnetometer, a power source or battery 1130, a circuit 1140 (e.g., a controller), and/or a solar panel 1150 that can be electrically coupled to one another. In aspects, the sensor 1120 may be mounted overhead, underneath, and/or on the side of the end gun 70. In aspects, the sensor 1120 may include a water quality sensor that measures, for example, iron, calcium, salts, and/or organic material. The moveable end gun 70 includes an elongated shaft 1104 defining a longitudinal axis. The moveable end gun 70 is pivotably coupled to a span (see e.g., FIG. 9) of the irrigation system 106 to enable the elongated shaft 1104 to pivot relative to the span about a pivot axis “A” extending through the elongated shaft 1104 that is transverse to the longitudinal axis of the elongated shaft 1104. The movable end gun 70 further includes an end gun nozzle 1106 disposed at an end portion of the elongated shaft 1104. The movable end gun 70 further includes a deflector assembly 1104a pinned to movable end gun 70 via a pin 1104c. The deflector assembly 1104a supports a deflector 1104b on a distal end portion thereof.

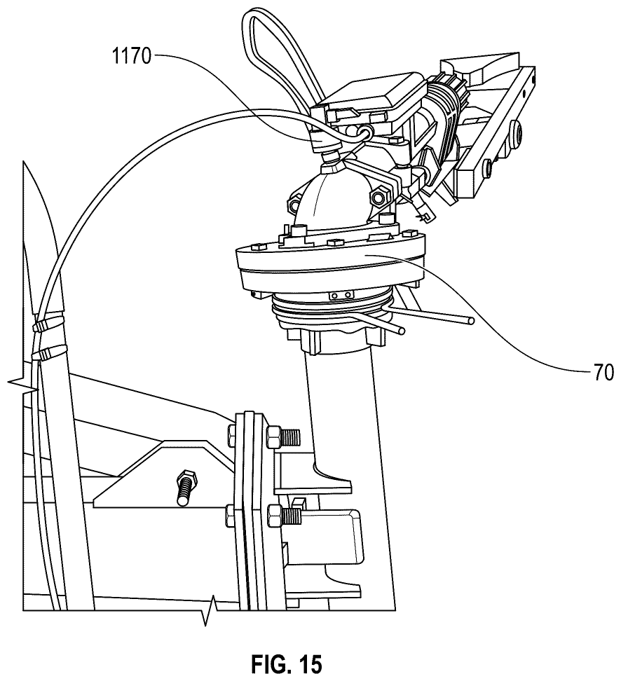

The moveable end gun 70 can further support an encoder assembly 1160 having an encoder 1162 and an encoder disc 1164 that is coupled to electronics enclosure 1110. A pressure sensor 1170 is also coupled to electronics enclosure 1110 to measure fluid flow pressure through end gun 70 (FIG. 15). Pressure may indicate the volume of water dispensed. Further, a reed switch 1180 or other magnetic switch can be coupled to moveable end gun 70 and disposed in proximity to a magnet 1190 supported on the pivot 20 (FIG. 1). As can be appreciated, any the disclosed electronics components can electrically couple to circuit 140 via wired or wireless connection. Notably, one or more of the accelerometer, gyroscope, magnetometer, encoder assembly, and/or any other suitable sensor(s) is configured to generate an electrical signal indicative of movement and/or positioning (e.g., acceleration, speed, distance, location, etc.) of the moveable end gun 70 relative to the pivot 20 over time (seconds, minutes, hours, days, years, etc.). The controller 200 is configured to receive the electrical signal and determine whether the moveable end gun requires maintenance based on the electrical signal. The controller 200 can send a signal and/or alert indicating the health of the end gun and/or whether maintenance is required thereon based on predetermined data or thresholds which may be part of a database, program and/or stored in memory (e.g., supported on the circuit, in the cloud, on a network, server, etc.).

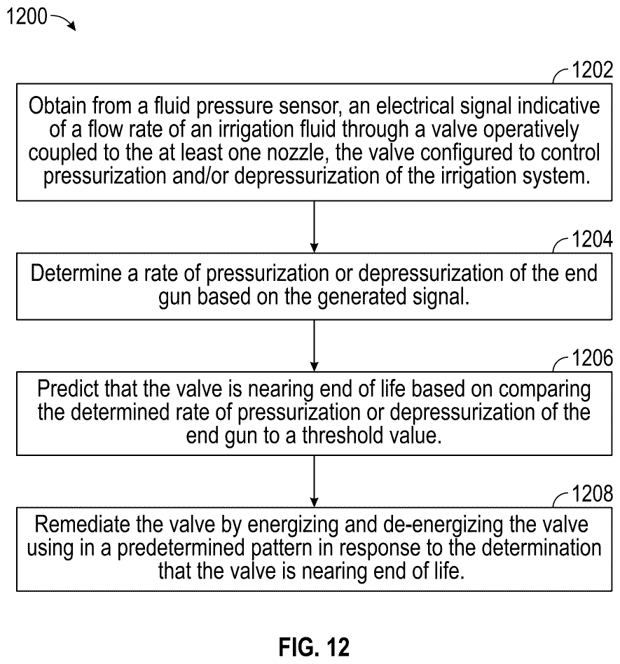

Referring to FIG. 12, a flow diagram for a method 1200 for monitoring a fluid pressure in an irrigation system is shown. Although the blocks of FIG. 12 are shown in a particular order, the blocks need not all be performed in the illustrated order, and certain blocks can be performed in another order. For example, FIG. 12 will be described below, with a controller 200 of FIG. 2 performing the operations. In aspects, the operations of FIG. 12 may be performed all or in part by another device, for example, a server, a user device, and/or a computer system. These variations are contemplated to be within the scope of the present disclosure.

Initially, at block 1202, the controller 200 causes the system 100 to obtain from a fluid pressure sensor 1170, an electrical signal indicative of a pressure of an irrigation fluid at a valve 902 operatively coupled to a nozzle (e.g., of end gun 70). The valve 902 is configured to control pressurization and/or depressurization of the irrigation system.

In aspects, the valve 902 may include a bleeder and/or a valve stem to enable closure of the valve.

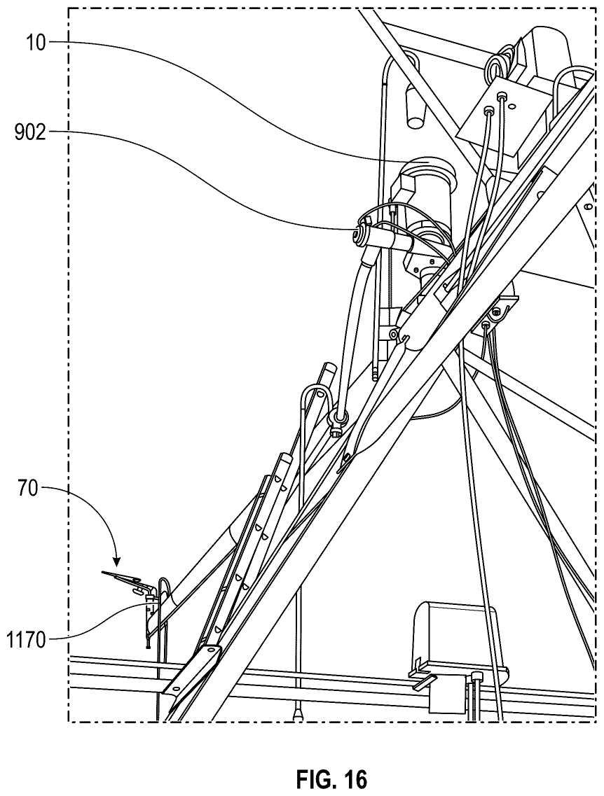

In aspects, the controller 200 may receive the generated electrical signal from a pressure sensor 1170 monitoring a valve 902 (FIG. 16). The valve 902 is configured to provide water for irrigation. The pressure sensor 1170 may sense, for example, pressure transient data. The pressure sensor 1170 may sense the pressure transient data over time and/or generate a resultant waveform over time. The controller 200 may determine whether valve 902, or one or more components thereof, requires maintenance based on the electrical signal and determine when valve 902 requires maintenance (e.g., valve operation issues that can lead to the valve sticking open or closed) based on the electrical signal. The determination may be performed by the machine learning model and/or by a classical algorithm. Controller 200 may provide an alert to the user of the determination that valve 902 requires maintenance and/or remediation.

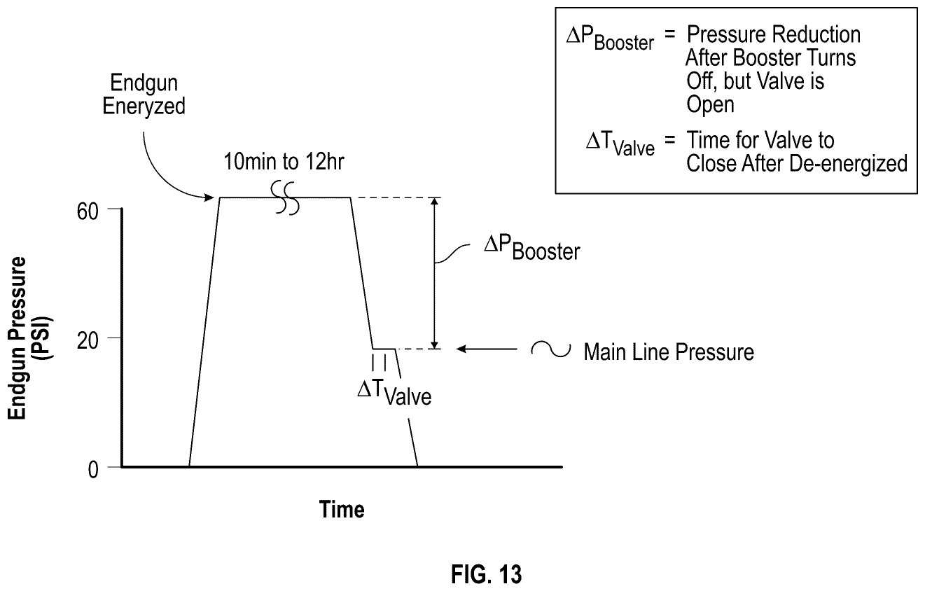

At block 1204, the controller 200 causes the system 100 to determine a rate of pressurization and/or depressurization of the end gun (and/or nozzle) based on the generated signal. When there is a mechanical problem with valve 902 (e.g., end gun valve) (FIG. 16), the rise and/or fall time of the signal generated by the pressure sensor 1170 over time (FIG. 13), for example, may change (e.g., decrease) or indicate other aberrations. Furthermore, the ratio of time to energize and/or de-energize may become less balanced, and the time spent energizing may become much longer than the de-energizing speed.

For example, when the booster pump 10 is de-energized, the valve 910 remains open for about five to about twenty seconds normally. In this small window of time, a sample of the main line pressure can be made using a pressure sensor, and it can be inferred what pressure the booster pump 10 is making.

If valve 902 is operating slowly or not at all, it can also be due to the valve actuating components, which include a solenoid valve that pressurizes the valve diaphragm to allow it to open. When the solenoid actuation valve is de-energized, pressure is vented out, enabling the valve to close. If the venting valve is plugged by insects, such as mud daubers, the valve 902 can fail to close. If the water lines between the solenoid valve are cracked or chewed through by animals, the valve can fail to open. If the valve itself is damaged, or the wiring sending the signal to open is damaged, the actuation valve will not open. The system 100 provides the benefit of monitoring the length of time the valve takes to open or close, which enables insight into the health of these components (e.g., the valve, the pump, and/or other subcomponents). For example, for a given pump speed setting (e.g., 1800 RPM), the length of time it takes for the pump to spin up and apply pressure (or spin down) provides insight into the health of the pump.

At block 1206, the controller 200 causes the system 100 to predict that the valve is nearing end of life based on comparing the determined rate of pressurization or depressurization of the end gun (and/or nozzle) to a threshold value. Although a valve is used as an example, the controller 200 may cause the system 100 to determine that the booster pump 10, or components thereof, are about to fail or has failed.

In aspects, the controller 200 may cause the system 100 to observe and trend over time the behavior of the valve 902. When a valve 902 behaves outside of the known acceptable parameters, irrigation technicians can be notified that the valve is nearing end of life and make a repair before failure occurs. As used herein, the term “end of life” includes the period of time towards the end of the life expectancy of a valve or other component where the valve or other component starts to show signs of failure and then eventually fail. For example, end gun valves typically have a life span of 7 to 10 years, where they are dependable. Towards the end of life, valves may start “sticking” or showing other signs of failure.

In aspects, the controller 200 may cause the system 100 to perform edge detection on the measured pressure vs time and determine that the valve is nearing end of life based on the edge detection. The edge detection may be used to detect, for example, discontinuities, changes in direction, edges, curves, and/or abrupt changes, in the measured pressure vs time. In aspects, the measured pressure vs time may be preprocessed with a sigma filter and/or other filters for reduction of noise in the ramps.

In aspects, the controller 200 may cause the system 100 to use machine learning to determine that the valve is nearing end of life based on the measured pressure over time.

At block 1208, the controller 200 causes the system 100 to remediate the valve by energizing and/or de-energizing the valve using in a predetermined pattern in response to the determination that the valve is nearing end of life.

The controller 200 may effectuate remediation of the stuck and/or sticking valve 902 by energizing and/or de-energizing valve 902 in one of several patterns. For example, a pulse-type waveform may be used to energize and/or de-energize valve 902. The controller 200 may control the frequency of the pulse (e.g., the rapidity of energizing and/or de-energizing) and/or the pulse width (e.g., the energized or de-energized time).

For example, in response to the determination that the valve is nearing end of life, the valve can be cycled on and off a number of times to attempt to break the corrosion loose on the internal valve stem, and get the valve operating normally. This can be considered a proper solution, as the valve most often will continue to operate normally the rest of the season. The corrosion often builds up when “wintering” the system, and just needs some “accelerated operation” such that it will function normally during the irrigation season.

For example, the bleeder and/or valve stem when malfunctioning, creates an air lock that can be cleared by cycling pressure on and off under control of the system 100, which can also clear this issue and allow for normal valve operation.

Referring to FIG. 13, a graph illustrating end gun pressure vs time is shown. When the valve for the end gun is initially turned on (i.e., energized), the pressure sensor measures an increase in pressure, for example, from 0 psi to about 60 psi. If a valve was failing or starting to fail, a symptom may be for this rise time to be slower than a typical rise time. For example, the valve may be operating slowly or not at all.

The end gun may then be left on for a period of time to enable the irrigation of a field. Initially the booster pump may be turned off, and the pressure would start to drop (delta P_{booster}). When the valve for the end gun is turned off (i.e., de-energized), the pressure sensor continues to measure a decrease in pressure over time. If a valve was failing, or starting to fail, a symptom may be for this fall time to be slower than a typical fall time. For example, the valve may be operating slowly or not at all.

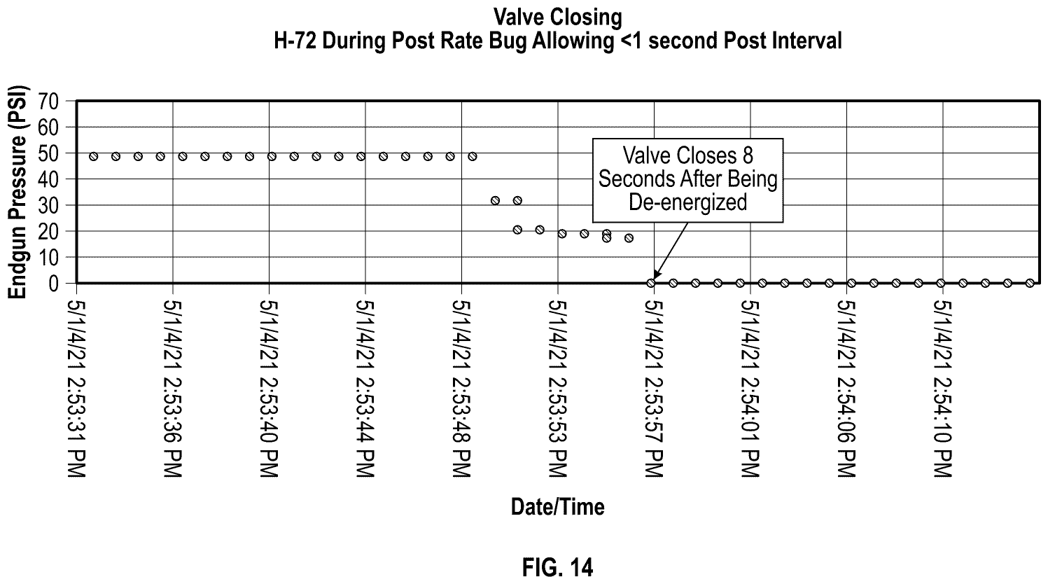

Referring to FIG. 14, a graph illustrating end gun pressure vs time for a healthy valve is shown. End gun pressure value data for this graph indicates that the valve is healthy. However, if the valve was worn, the time to close could take longer than the approximately 20 seconds shown in the graph. Thus, the system 100 is able to use this data to predict a hard failure prior to the hard failure occurring.

Referring to FIG. 15, a rear perspective view of an example end gun 70 and pressure sensor 1170 is shown. In this example, the pressure sensor 1170 may be located at the end gun 70.

Referring to FIG. 16, a bottom perspective view of an example end gun 70 with a remote-mounted booster pump 10 is shown. In this example, the valve 902 and the booster pump 10 are remotely located from the end gun 70 and the pressure sensor 1170.

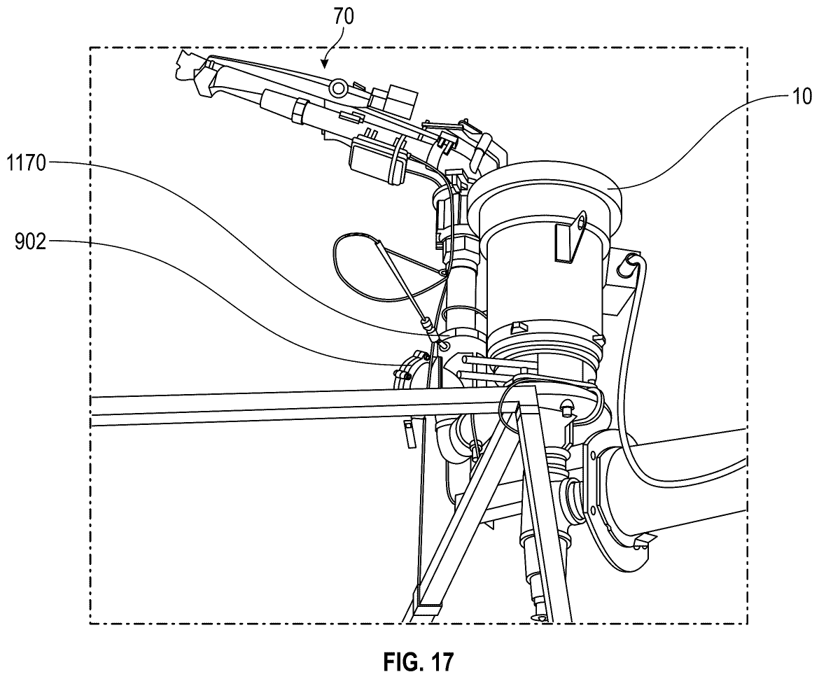

Referring to FIG. 17, a side perspective view of an example booster and pressure sensor mounted near the end gun are shown. In this example, the valve 902 and the booster pump 10 are located proximate to the end gun 70 and the pressure sensor 1170.

Although an irrigation system is used as an example, the disclosed systems and methods may be used advantageously in other environments, such as, but not limited to dust management in a mine, and/or irrigation of turf of a stadium.

In one aspect of the present disclosure, the disclosed algorithms may be trained using supervised learning. Supervised learning is the machine learning task of learning a function that maps an input to an output based on example input-output pairs. The ML model infers a function from labeled training data consisting of a set of training examples. In supervised learning, each example is a pair, including an input object (typically a vector) and a desired output value (also called the supervisory signal). A supervised learning algorithm analyzes the training data and produces an inferred function, which can be used for mapping new examples. In various embodiments, the algorithm may correctly determine the class labels for unseen instances. This requires the learning algorithm to generalize from the training data to unseen situations in a “reasonable” way.

In various embodiments, the neural network may be trained using training data, which may include, for example, different soil conditions or different component characteristics (e.g., current, voltage, pressures, duty, etc.). The algorithm may analyze this training data and produce an inferred function that may allow the algorithm to identify component failures or changes in health, based on the generalizations the algorithm has developed from the training data. In various embodiments, training may include at least one of supervised training, unsupervised training, and/or reinforcement learning.

In some aspects, a user can initiate a training session while watching operation to simplify setup on each unique end gun and pivot combination since pressures and flows may differ. When the end gun is deemed to be operating normally, the user can open a training window which will then be used to calibrate or train the analytics for future anomaly detection. For instance, Linux (R), which may run a Python (R) script, for example, can be utilized to effectuate prediction. In aspects, analytics may also be performed in the sensor using platforms such as Tensor Flow (R) lite.

In various embodiments, the neural network may include, for example, a three-layer temporal convolutional network with residual connections, where each layer may include three parallel convolutions, where the number of kernels and dilations increase from bottom to top, and where the number of convolutional filters increases from bottom to top. It is contemplated that a higher or lower number of layers may be used. It is contemplated that a higher or lower number of kernels and dilations may also be used.

In aspects, the disclosed monitoring systems can be a separate system that can be selectively attached or retrofitted to an end gun, or in some aspects, the monitoring system 100 can be built directly into an end gun.

In aspects, the controller 200 may receive a generated electrical signal from a pressure sensor 1170 configured to couple to a moveable end gun of the irrigation system 106. The pressure sensor 1170 is configured to generate an electrical signal indicative of an irrigation fluid pressure of a portion of the irrigation system 106 over time.

In aspects, either sensor 102, 1170 may be coupled to the end of the pivot 20, which may include being coupled to a nozzle (e.g., the end gun 70). The end of the pivot 20 is generally located near the last nozzle. Near is defined as at least about 75% of the distance from a water source to the irrigation system 106. For example, the end of the pivot 20 may be located at or beyond the last nozzle.

As can be appreciated, securement of any of the components of the disclosed apparatus can be effectuated using known securement techniques such welding, crimping, gluing, fastening, etc.

Persons skilled in the art will understand that the structures and methods specifically described herein and illustrated in the accompanying figures are non-limiting exemplary aspects, and that the description, disclosure, and figures should be construed merely as exemplary of particular aspects. It is to be understood, therefore, that this disclosure is not limited to the precise aspects described, and that various other changes and modifications may be effectuated by one skilled in the art without departing from the scope or spirit of the disclosure. Additionally, it is envisioned that the elements and features illustrated or described in connection with one exemplary aspect may be combined with the elements and features of another without departing from the scope of this disclosure, and that such modifications and variations are also intended to be included within the scope of this disclosure. Indeed, any combination of any of the disclosed elements and features is within the scope of this disclosure. Accordingly, the subject matter of this disclosure is not to be limited by what has been particularly shown and described.

What is claimed is:

1. An irrigation maintenance system for effectuating maintenance of an irrigation system, the irrigation system including at least one nozzle for dispensing irrigation fluid, and a valve and/or booster pump for controlling a pressure of the irrigation fluid dispensed from the at least one nozzle, the irrigation maintenance system comprising:
a fluid pressure sensor configured to generate electrical signals indicative of the pressures of the irrigation fluid at the at least one nozzle over time;
a processor; and
a memory, including instructions stored thereon, which, when executed by the processor, cause the irrigation maintenance system to:
obtain the generated electrical signals;
determine a rate of pressurization or depressurization of the irrigation fluid at the at least one nozzle based on the generated electrical signals; and
predict when the valve and/or the booster pump of the irrigation system is at or nearing end of life based on comparing the determined rate of pressurization or depressurization of the irrigation fluid at the at least one nozzle to a threshold value.

2. The irrigation maintenance system of claim 1, wherein the instructions, when executed, further cause the irrigation maintenance system to:
provide an indication to a user when the valve and/or the booster pump is at or nearing end of life based on the determination.

3. The irrigation maintenance system of claim 1, wherein the fluid pressure sensor is disposed adjacent to the at least one nozzle.

4. The irrigation maintenance system of claim 1, wherein the fluid pressure sensor is coupled to an end portion of a span of a pivot of the irrigation system.

5. The irrigation maintenance system of claim 1, wherein the at least one nozzle is supported on a movable end gun of the irrigation system.

6. The irrigation maintenance system of claim 1, wherein the nozzle is movably mounted on a pivot of the irrigation system.

7. The irrigation maintenance system of claim 1, further comprising an analytics engine configured to perform the determinations, wherein the analytics engine includes a machine learning model, and wherein the machine learning model is based on a deep learning network, a classical machine learning model, or combinations thereof.

8. The irrigation maintenance system of claim 7, wherein the instructions, when executed, further cause the irrigation maintenance system to:
input the determined rate of pressurization or depressurization of the irrigation fluid at the at least one nozzle into the analytics engine; and
predict by the analytics engine when the valve and/or the booster pump is at or nearing end of life.

9. The irrigation maintenance system of claim 1, wherein the instructions, when executed, further cause the irrigation maintenance system to:
remediate the valve and/or the booster pump by energizing and/or de-energizing the valve and/or the booster pump in a predetermined pattern in response to the determination that the valve and/or the booster pump is nearing end of life.

10. The irrigation maintenance system of claim 1, wherein the instructions, when executed, further cause the irrigation maintenance system to:
perform edge detection to the determined rate of pressurization or depressurization of the irrigation fluid at the at least one nozzle based on the generated electrical signals; and
predict when the valve and/or the booster pump is at or nearing end of life based on the edge detection.

11. A computer-implemented method for irrigation system maintenance, the irrigation system including at least one nozzle for dispensing irrigation fluid, and a valve and/or booster pump for controlling a pressure of the irrigation fluid dispensed from the at least one nozzle, the method comprising:
obtaining from a fluid pressure sensor, electrical signals indicative of a pressure of an irrigation fluid at a valve operatively coupled to the at least one nozzle, the valve configured to control pressurization and/or depressurization of the irrigation system;
determining a rate of pressurization or depressurization of the irrigation fluid at the at least one nozzle based on the generated electrical signals; and
determining when the valve and/or the booster pump is at or nearing end of life based on comparing the determined rate of pressurization or depressurization of the irrigation fluid at the at least one nozzle to a threshold value.

12. The computer-implemented method of claim 11, further comprising:
providing an indication to a user when the valve and/or the booster pump is at or nearing end of life based on the determination.

13. The computer-implemented method of claim 11, further comprising:
performing edge detection to the determined rate of pressurization or depressurization of the irrigation fluid at the at least one nozzle based on the generated electrical signals.

14. The computer-implemented method of claim 13, further comprising:
predicting when the valve and/or the booster pump is at or nearing end of life based on the edge detection.

15. The computer-implemented method of claim 11, wherein the determinations are performed by an analytics engine, wherein the analytics engine includes a machine learning model, and wherein the machine learning model is based on a deep learning network, a classical machine learning model, or combinations thereof.

16. The computer-implemented method of claim 15, further comprising:
inputting the determined rate of pressurization and/or depressurization of the irrigation fluid at the at least one nozzle into the analytics engine; and
predicting by the analytics engine when the valve and/or the booster pump is at or nearing end of life.

17. The computer-implemented method of claim 11, further comprising:
remediating the valve and/or the booster pump by energizing and/or de-energizing the valve and/or the booster pump in a predetermined pattern in response to the determination that the valve and/or the booster pump is nearing end of life.

18. The computer-implemented method of claim 17, further comprising:
controlling the energizing and/or de-energizing of the valve and/or the booster pump using a pulse waveform.

19. The computer-implemented method of claim 18, further comprising:
controlling the frequency of a pulse and/or a pulse width of the pulse waveform.

20. A non-transitory computer-readable medium storing instructions which, when executed by a processor, cause the processor to perform a method comprising:
obtaining from a fluid pressure sensor, electrical signals indicative of a pressure of an irrigation fluid at a valve operatively coupled to the at least one nozzle, the valve configured to control pressurization and/or depressurization of the irrigation system;
determining a rate of pressurization or depressurization of the irrigation fluid at the at least one nozzle based on the generated electrical signals;
determining when the valve and/or the booster pump is at or nearing end of life based on comparing the determined rate of pressurization or depressurization of the irrigation fluid at the at least one nozzle to a threshold value; and
remediating the valve and/or booster pump by energizing and/or de-energizing the valve in a predetermined pattern in response to the determination that the valve is nearing end of life.
